(19) United States
(12) Patent Application Publication
(10) Pub. No.: US 2022/0383391 A1
(43) Pub. Date: Dec. 1, 2022

(54) PERSONALIZED SELECTION OF PICKUP SLOTS USING MACHINE LEARNING

(71) Applicant: Cognetry Labs Inc., Hillsboro, OR (US)

(72) Inventors: Balasubramanian Krishnamoorthy, Portland, OR (US); Muthukumar Udaiyanathan, Hillsboro, OR (US); Sandeep Sivanpillai Nair, Thiruvananthapuram (IN)

(21) Appl. No.: 17/331,387

(22) Filed: May 26, 2021

(51) Int. Cl. G06Q 30/06; G06Q 10/08; G06N 20/00

(52) U.S. Cl. CPC G06Q 30/0633; G06Q 10/087; G06N 20/00

(57) ABSTRACT

A system for personalized selection of pickup slots using machine learning is disclosed. A historical data is received related to past customer orders placed by a customer at a retail store within a first period. A set of inputs which includes slot-related information related to timeslots available at the retail store within a second period, inventory information, and order preparation constraints are received. A set of training data is prepared based on the historical data and the set of inputs. Thereafter, a machine learning model is trained on the prepared set of training data for a timeslot prediction task. A customer order is received for an in-store pickup at the retail store within the second period. By using the trained machine learning model, a first timeslot is determined for the in-store pickup of the customer order. The first timeslot is displayed on a customer device.

### CROSS-REFERENCE TO RELATED APPLICATIONS/INCORPORATION BY REFERENCE

None.

### FIELD

Various embodiments of the disclosure relate to digital commerce. More specifically, various embodiments of the disclosure relate to a system and method for personalized selection of pickup slots using machine learning.

### BACKGROUND

Advancements in digital commerce have led to an emergence of a large number of retail stores that accept orders online from customers. Such orders may typically be delivered at a delivery address of the customer or may be available for an in-store pickup at the retail store. After the order is placed or at the time of placing the order, the retail store may offer customers an option to pick up their orders from the retail store at certain pickup time or within a pickup time-window. Typically, all available pickup time windows or pickup times within a given duration (for example, next 7 days) may be presented to the customer as available options for an in-store pickup from the retail store. In many instances, the customer may select a pickup time window or a pickup time that may give less time to the retail store to prepare the order. In such instances, the preparation of order may be delayed. Even though the customer may arrive on time to pick up the order, the customer may end up waiting at the retail store for an extended period of time, which may affect the overall shopping experience of the customer.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and method for personalized selection of pickup slots using a machine learning model is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for personalized selection of pickup slots using a machine learning model, in accordance with an embodiment of the disclosure.

FIG. 2 is a block diagram that illustrates an exemplary system for personalized selection of pickup slots, in accordance with an embodiment of the disclosure.

FIG. 3 is a diagram that illustrates an exemplary processing pipeline for personalized selection of pickup slots using a machine learning model, in accordance with an embodiment of the disclosure.

FIG. 4 is a diagram that illustrates another exemplary processing pipeline for personalized selection of pickup slots, in accordance with an embodiment of the disclosure.

FIG. 5 is a diagram that illustrates an example user-interface of a customer device for display of one or more timeslots for selection of pickup slot, in accordance with an embodiment of the disclosure.

FIG. 6 is a flowchart that illustrates exemplary operations for personalized selection of pickup slots using a machine learning model, in accordance with an embodiment of the disclosure.

### DETAILED DESCRIPTION

The described implementations may be found in a disclosed system and method for personalized selection of pickup slots using machine learning. Exemplary aspects of the disclosure may include the system, such as, a cloud server, a group of cloud servers, a Software-as-a-Service (SaaS) application server, a distributed computing server, a mainframe system, a work-station, a personal computer, a mobile device, or any electronic computing-device. The system may receive historical data related to a set of past customer orders placed by a customer at a retail store within a first period (e.g., a certain day, week, or month).

The system may receive a set of inputs, including, but not limited to, slot-related information, inventory information, and order preparation information. The slot-related information may be related to a first set of timeslots, which may include a set of timeslots (e.g., a set of half hour or one hour time windows) available at the retail store within a first period (e.g., a certain day, week, or month). The inventory information may be related to items that may be sold by the retail store. The order preparation constraints may be related to a number of human workers who may work at or may be employed with the retail store and may service an order received by the retail store. The received set of inputs may further include a number of parking spots available for the in-store pickup. Further, the received set of inputs may include initial weights for objectives, such as, but not limited to, a first objective to maximize a service level for the received customer order above a service level threshold, and a second objective to maximize a resource utilization of the number of human workers within each of the first set of timeslots above a utilization threshold.

The system may prepare a set of training data based on the received historical data and the received set of inputs. The system may train a machine learning model on the prepared set of training data. The machine learning model may be trained for a timeslot prediction task (e.g., a personalized pickup timeslot prediction task). The system may receive a customer order. The customer order may be placed by the customer at the retail store. The customer order may be placed from a customer device associated with a customer. The customer order may be scheduled for an in-store pickup of a set of items from the retail store within the second period. The system may determine, by using the trained machine learning model, a first timeslot (e.g., a personalized timeslot) from the first set of timeslots for the in-store pickup of the received customer order. The system may control the customer device to display the determined first timeslot.

The disclosed system may leverage historical data (e.g., historical data of at 30 past customer orders placed by the customer at the retail store) to train the machine learning model and may use such trained model to predict personalized pickup timeslots for individual customer, thereby enhancing individual customer's shopping experience with the retail store. As the machine learning model may be trained (and retrained) with data of customer orders (from the same customer), the model may learn changes in pickup patterns or preferences of the customer and may output timeslot predictions that may remain relevant (and personalized) for the customer at all times.

The disclosed system may determine an optimal timeslot which may not only accommodate the customer order but may also maximize service levels of the retail store. The disclosed system may leverage the information related to resources available at the retail store and customer orders to determine pickup timeslots. Such timeslots provide enough time to the workers at the retail store to prepare customer orders (before customers arrive at the pickup timeslots). Also, such timeslots may optimally reduce a pickup wait time for the customers within individual pickup timeslots. Therefore, the customer may not have to wait for extended period of time as the customer arrives to pick up the order in the first timeslot.

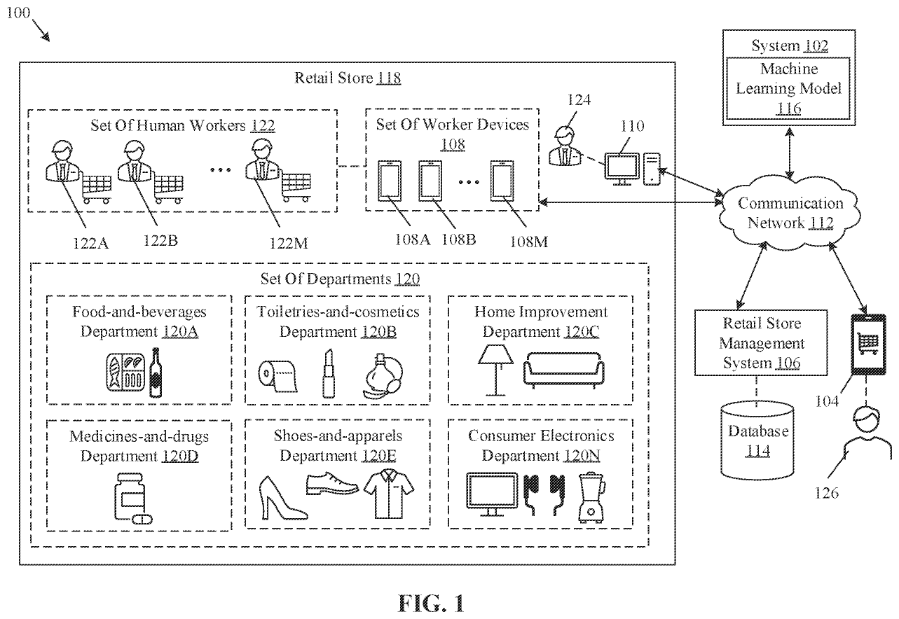

FIG. 1 is a block diagram that illustrates an exemplary network environment for personalized selection of pickup slots using machine learning model, in accordance with an embodiment of the disclosure. With reference to FIG. 1, there is shown a network environment 100. The network environment 100 may include a system 102, a customer device 104, a retail store management system 106, a set of worker devices 108, a store manager device 110, and a communication network 112. The set of worker devices 108 may include a first worker device 108A, a second worker device 108B, . . . , and an Mth worker device 108M. The retail store management system 106 may be associated with a database 114. The system 102 may include a machine learning model 116 and may be communicatively coupled to the customer device 104, the retail store management system 106, the set of worker devices 108, and the store manager device 110, via the communication network 112.

In FIG. 1, there is further a shown a block diagram of a retail store 118. The retail store 118 may include a set of departments 120, such as, but not limited to, a food-and-beverages department 120A, a toiletries-and-cosmetics department 120B, a home improvement department 120C, a medicines-and-drugs department 120D, a shoes-and-apparels department 120E, . . . , and a consumer electronics department 120N. The set of departments 120 shown in FIG. 1 is presented merely as an example and should not be construed as limiting for the disclosure. The present disclosure may be applicable to other types of departments or sub-departments at a retail store. The description of other types of departments or sub-departments has been omitted from the disclosure for the sake of brevity. Also, the number of departments in FIG. 1 is presented merely as an example and should not be construed as limiting for the disclosure. The set of departments 12 may include more than or less than six departments, without departing from the scope of the disclosure.

As shown in FIG. 1, the retail store 118 may be associated with a set of human workers 122. For example, the set of human workers 122 may be employed or contracted to work at the retail store 118 to service orders received by the retail store 118. The set of human workers 122 include a first human worker 122A, a second human worker 122B, . . . , and an Mth human worker 122M. Each of the set of human workers 122 may operate one or more worker devices (of the set of worker devices 108). For example, the first human worker 122A may operate the first worker device 108A, the second human worker 122B may operate the second worker device 108B, and the Mth human worker 122M may operate the Mth worker device 108M. The retail store 118 may be further associated with a store manager 124. The store manager 124 may be responsible for performing several tasks, such as, but not limited to, managing the day-to-day operations of the retail store, supervising the set of human workers 122, overseeing inventory, and ensuring that targets set by the retail store are achieved to a certain extent. The store manager 124 may operate the store manager device 110. There is further shown a customer 126 who may operate the customer device 104 to orders items at the retail store 118.

The system 102 may include suitable logic, circuitry, interfaces, and/or code that may be configured to select personalized timeslots for an in-store pickup of orders placed (or about to be placed) at the retail store 118 within a given period. Such timeslots may be determined based on various types of information, such as historical data related to the set of past customer orders, slot-related information related to timeslots available at the retail store 118 within a period, inventory information related to items sold by the retail store 118, and order preparation constraints. Example implementations of the system 102 may include, but are not limited to, a cloud server (public, private, or hybrid), a distributed computing server or a cluster of servers, a Software-as-a-Service (SaaS) application server, an edge computing system that includes a network of distributed compute/edge nodes), a mainframe system, a work-station, a personal computer, or a mobile device.

In an exemplary embodiment, the system 102 may include a frontend subsystem and a backend subsystem. The frontend subsystem may be deployed on-premises or at a location of entities, such as retail stores (which may be registered with or connected to the system 102) and fulfillment centers (which may be associated with the retail stores or may operate independently). In an embodiment, the frontend subsystem may be a client-side application, accessible on worker devices, store manager devices, or on customer devices. The frontend subsystem may be configured to display a user interface (UI) which may include UI elements to allow customers, human workers, or store managers to provide inputs and view information related to orders or workers. The backend subsystem may include a server-side application, which may execute all instructions related to order scheduling and fulfillment for retail stores (registered with the system 102).

The customer device 104 may include suitable logic, circuitry, interfaces, and/or code that may be configured to enable a user (e.g., the customer 126) associated with the customer device 104 to place a customer order and to schedule the customer order for an in-store pickup at the retail store 118. In an embodiment, the customer device 104 may include a web client to access a client-side application or may include an installation of a software application. The client-side application or the software application may include a user interface for the customer 126 to execute several tasks, such as, but not limited to, to place the customer order at the retail store 118, interact with the staff at the retail store 118, schedule/select timeslots for the in-store pickup, or to track a status of the placed customer order. Through the client-side application or the software application, the customer device 104 may display a set of timeslots to choose from for the in-store pickup of the customer order. Examples of the customer device 104 may include, but are not limited to, a kiosk device, a computer work-station, a personal computer, a mobile phone, a smartphone, a cellular phone, a tablet computing device, a gaming device, a server, a mainframe machine, a consumer electronic (CE) device, or any computing device with an inbuilt or installed web-client or a software application associated with the retail store 118.

The retail store management system 106 may include suitable logic, circuitry, interfaces, and/or code that may be configured to enable management of operations of one or more retails stores (e.g., the retail store 118) or a chain of retail stores. The retail store management system 106 may include a set of tools, such as, but not limited to, an inventory management system, a supply chain management system, a point-of-sale (PoS) management system, an order management system, an online marketing system, an e-commerce management system, an accounting management system, a customer relationship management (CRM) system, an enterprise resource planning (ERP) system, or a human resource (HR) management system. The retail store management system 106 may enable, for example, the retail store 118 to manage at least one of, but not limited to, an inventory of orders, customer orders, employee shifts/staffing, billing, and order preparation/fulfillment status of customer orders with the retail store 118.

In an embodiment, the retail store management system 106 may be configured to use the database 114 to store information related to the retail store 118. Such information may be provided as a set of inputs to the system 102. The stored information may include, for example, slot-related information, inventory information, order preparation constraints, parking spot information, and the like. The stored information related to the set of inputs may further include historical data related to a set of past customer orders.

In one embodiment, the retail store management system 106 may be an on-premises system located at the facility of the retail store 118. In another embodiment, the retail store management system 106 may be located outside the retail store 118. For example, the retail store management system 106 may be an edge computing device, a fog-computing system (with at least one edge node located near the premises of the retail store 118), or a set of distributed computing devices. Alternatively, the retail store management system 106 may be a server (such as a cloud server). Other examples of the retail store management system 106 may include, but are not limited to, a SaaS application server, a database server, a distributed computing server, a mainframe system, a work-station, a personal computer, or a mobile device.

The set of worker devices 108 may include suitable logic, circuitry, interfaces, and/or code that may be configured to enable the set of human workers 122 to service the customer orders. In an embodiment, the set of worker devices 108 may include a web-client to access a client-side application or a pre-installed software application associated with the retail store 118. The client-side application or the software application may include a user-interface for human workers (e.g., the set of human workers 122) of the retail store 118. Through the web-client or the software application, each worker device (e.g., the first worker device 108A) may receive a notification from the system 102 and/or the store manager device 110. The notification may include a schedule for servicing the customer order and a set of instructions for the human worker (e.g., the first human worker 122A) to service the customer order or a sub-order thereof. Through the web-client or the software application, the worker device (e.g., the first worker device 108A) may transmit a notification associated with the fulfillment of the customer order or a part of the customer order to the store manager device 110, the retail store management system 106, and/or the system 102. Examples of the set of worker devices 108 may include, but are not limited to, a kiosk device, a computer work-station, a personal computer, a mobile phone, a smartphone, a cellular phone, a tablet computing device, a gaming device, a server, a Point-of-Sale Device, a barcode reader, a mainframe machine, a consumer electronic (CE) device, or any computing device with capability to execute a web-client or a software application associated with the retail store 118.

The store manager device 110 may include suitable logic, circuitry, interfaces, and/or code that may be configured to display a user-interface, through which the store manager 124 may manage operations of the retail store 118. The operations of the retail store 118 may include, for example, assignment of tasks to the set of human workers 122 for servicing customer orders, order tracking, inventory management, sales, billing, logistics, customer relationship management, and the like.

In an embodiment, the store manager device 110 may include a web-client to access a client-side application or a pre-installed software application associated with the retail store 118. The client-side application or the software application may include the user-interface for the store manager 124 of the retail store 118. Through the web-client or the software application, the store manager device 110 may receive a notification related to customer orders. For example, the notification may be related to the customer orders which may be placed at the retail store 118 within a specific period (for example, last 5 days) and are yet to be serviced or fulfilled. The notification may include details of the customer order and a schedule for the pickup of the customer order. Additionally, the notification may include a timeslot (and/or a servicing time) in which the customer order (or its suborders) can be serviced before the pickup schedule. Based on the received notification, the store manager device 110 may transmit a set of instructions associated with servicing of the customer order to one or more devices in the set of worker devices 108. Examples of the store manager device 110 may include, but are not limited to, a kiosk device, a computer work-station, a personal computer, a mobile phone, a smartphone, a cellular phone, a tablet computing device, a gaming device, a server, a mainframe machine, a consumer electronic (CE) device, or any computing device with capability to execute a web-client or a software application associated with the retail store 118.

The communication network 112 may include a communication medium through which the system 102 may be communicatively coupled to the customer device 104, the retail store management system 106, the set of worker devices 108, and the store manager device 110. Examples of the communication network 112 may include, but are not limited to, the Internet, a cloud network, a Wireless Fidelity (Wi-Fi) network, a Personal Area Network (PAN), a Local Area Network (LAN), or a Metropolitan Area Network (MAN), a mobile wireless network, such as a Long-Term Evolution (LTE) network (for example, 4th Generation or 5th Generation (5G) mobile network (i.e., 5G New Radio)). Various devices of the network environment 100 may be configured to connect to the communication network 112, in accordance with various wired or wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, Bluetooth (BT) communication protocols, or a combination thereof.

The database 114 may be configured to store the information related to, for example, the retail store 118, customers of the retail store 118, and customer orders placed at the retail store 118. Such information may be used to provide a set of inputs to the system 102. The database 114 may be a relational or a non-relational database. The database 114 may be stored on a device, such as the retail store management system 106, the system 102, or a server different from the retail store management system 106 and the system 102. The device which stores the database 114 may be configured to receive a request from the system 102, through the communication network 112. Based on the received request, the device may be configured to retrieve the set of inputs from the database 114 and may transmit the set of inputs to the system 102, through the communication network 112.

The machine learning model 116 may be a model which may be trained to identify a relationship between inputs, such as features in a training dataset of historical data related to the set of past customer orders and output labels, such as timeslots selected in past for pickup of the customer orders. Specifically, the machine learning model 116 may be a timeslot prediction model that may be trained on a task to predict the timeslots for pickup of the customer orders. In an embodiment, for each customer of the retail store 118, a separate machine learning model may be trained on historical order data associated with the respective customer. The machine learning model 116 may be defined by its hyper-parameters, for example, a number of weights, a cost function, an input size, a number of layers or nodes, and the like. Such hyper-parameters of the machine learning model 116 may be tuned before or after the training of the machine learning model 116.

In training, an input feature from a training dataset may be fed to the machine learning model 116 and weights of the model may be updated based on a supervised learning algorithm. The weights may be iteratively updated until the loss associated with the model is below a threshold. After several epochs of training on features of the training dataset, the machine learning model 116 may be trained to output a result for a set of inputs. The result may include a predicted timeslot for a set of inputs. Examples of the machine learning model 116 may include, but is not limited to, a Support Vector Machine (SVM) model, a deep learning (DL) model (e.g., a deep neural network (DNN)) based on artificial neural networks), or a hybrid ML/DL model.

In an embodiment, the machine learning model 116 may be a neural network, which may be referred to as a computational network or a system of artificial neurons (also referred to as nodes). The nodes of the machine learning model 116 may be arranged in a plurality of layers, as defined in a neural network topology of the machine learning model 116. The plurality of layers of the machine learning model 116 may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the machine learning model 116. Outputs of each hidden layer may be coupled to inputs of at least one node in other layers of the machine learning model 116. Node(s) in the final layer may receive inputs from at least one hidden layer to output a result.

Each node of the machine learning model 116 may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the machine learning model 116. All or some of the nodes of the machine learning model 116 may correspond to same or a different same mathematical function.

In an embodiment, the machine learning model 116 may include electronic data, which may be implemented as, for example, a software component of an application executable on the system 102. The machine learning model 116 may rely on libraries, external scripts, or other logic/instructions for execution by a processing device, such as, the system 102. The machine learning model 116 may include code or routines to enable a computing device, such as, the system 102, to perform one or more operations for the timeslot prediction task. Additionally, or alternatively, the machine learning model 116 may be implemented using hardware including a processor, a co-processor, a microprocessor (e.g., to perform or control performance of one or more operations), a field-programmable gate array (FPGA), or an application-specific integrated circuit (ASIC). Alternatively, in some embodiments, the machine learning model 116 may be implemented using a combination of hardware and software.

The retail store 118 may be a physical store that may operate according to a BOPIS system (i.e., Buy Online, Pick-up in Store). For example, the retail store 118 may list items (which may include goods, services, or a combination thereof) available for sale at the retail store 118 (or at its warehouses or nearby stores chains), on a website, a web application, or a software application (such as a mobile application or a desktop application). The website or the web application may be accessed via a web-client and the software application may be installed on various customer devices. In addition to the BOPIS system, the retail store 118 may also operate according to other methods, such as buy online and get home delivery of orders. For example, a customer may choose to receive items in the customer order through a physical delivery option or an in-store pickup option. If the customer chooses the physical delivery option, one or more items purchased by the customer (such as the customer 126) may be shipped to the delivery address associated with the customer. If the customer chooses the in-store pickup option, the customer order may be prepared and provided to the customer at a physical location associated with the retail store 118. The physical location may be a location (such as a checkout counter or a drive through counter) within the premises of the retail store 118. Additionally, or alternatively, the physical location may include a set of parking spots at the retail store 118 or designated spots reserved by the retail store 118 for pick-up of serviced orders. In some instances, the retail store 118 may allow customers to add more items to a serviced customer order, while visiting the retail store 118 to pick-up the items of a serviced customer order.

The retail store 118 may be organized into different departments that may include one or more sub-departments for efficient servicing of the customer orders. For example, as shown in FIG. 1, the retail store 118 may include the set of departments 120, such as, but not limited to, the food-and-beverages department 120A, the toiletries-and-cosmetics department 120B, the home improvement department 120C, the medicines-and-drugs department 120D, the shoes-and-apparels department 120E, . . . , and the consumer electronics department 120N.

In operation, the system 102 may receive historical data related to a set of past customer orders placed by the customer 126 at retail store 118 within a first period (e.g., a day, a week, or a month). By way of example, and not limitation, for each customer order of the set of past customer orders, the historical data may include suborders split into departments at the retail store 118, a size of each of the suborders, a time of service for each of the suborders, a date and time at which a respective customer order was placed, a date and a timeslot at which the respective customer order was picked up, and a numbers of items which were out-of-stock in each of the departments.

The system 102 may further receive a set of inputs from the retail store management system 106. For example, the retail store management system 106 may retrieve the set of inputs from the database 114 and may transmit such inputs to the system 102, via the communication network 112. The received set of inputs may include, for example, slot-related information, inventory information, order preparation constraints, and the like. The slot-related information may be related to a first set of timeslots (e.g., one or more free timeslots of half hour or one hour each) available at the retail store 118 within a second period (e.g., a day, a week, or a month). The inventory information may be related to items sold by the retail store 118. For example, the inventory information may include information related to an identity and a quantity of different items available in the each of the set of departments 120 and/or a warehouse associated with the retail store 118. The order preparation constraints may be related to a number of human workers (e.g., the set of human workers 122) at the retail store 118. For example, the order preparation constraints may include an average time that may be required by each human worker to service a sub-order of a certain size including items associated with a certain department or sub-department of the retail store 118.

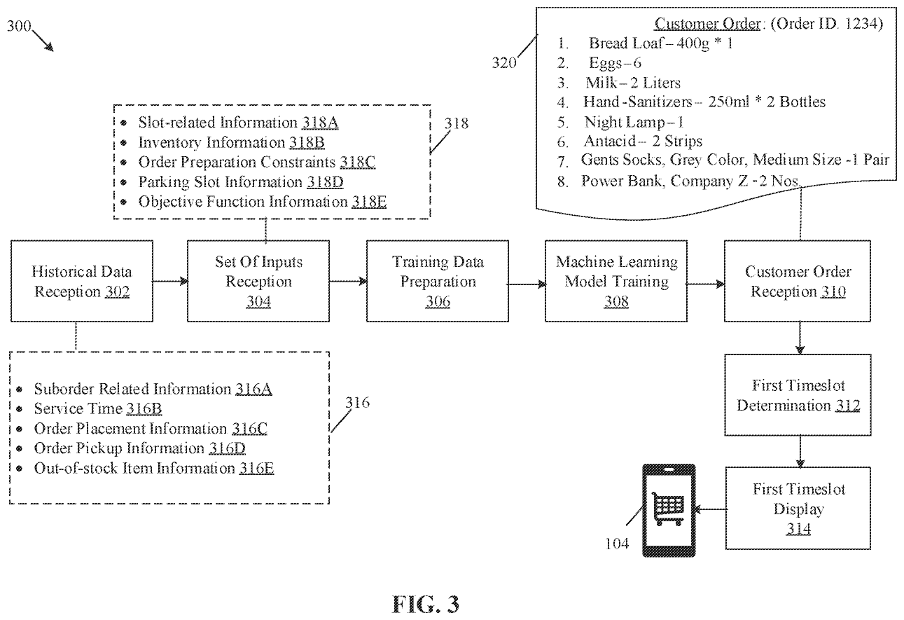

The system 102 may prepare a set of training data based on the received historical data and the received set of inputs. For example, information included in the received historical data and the received set of inputs may be parsed into separate input features (or individual datapoints) and output labels to generate the set of training data. Thereafter, the system 102 may train the machine learning model 116 on the prepared set of training data. Each input feature or datapoint may include, for example, suborders split into departments at the retail store 118, a size of each of the suborders, the time of service for each of the suborders, a date and time at which a respective customer order was placed, and a number of items which were out-of-stock in each of the departments. Input features (or datapoints) in the prepared training data may also include a first set of timeslots available at the retail store 118 (included in the slot-related information), a list of items sold by the retail store 118 (included in the inventory information), and the order preparation constraints. The output labels in the training data may include, for example, the date and the timeslot at which the respective customer order was picked up. Details of training the machine learning model 116 are described, for example, in FIG. 3.

At any time-instant, the system 102 may be configured to receive a customer order, which may be placed by the customer 126 at the retail store 118 and may need to be scheduled for an in-store pickup at the retail store 118 within a second period. The second period may be, for example, a period of next five days from the day the customer order is received or placed. The system 102 may receive the customer order from the customer device 104 (or the retail store management system 106) for an in-store pickup of the set of items at the retail store 118. By way of example, and not limitation, the customer device 104 may display a user-interface onto a display screen of the customer device 104. The user-interface may be accessed through a web client or may be a part of a software application pre-installed on the customer device 104. Through the displayed user-interface, the customer device 104 may receive a user input related to a purchase of a set of items from the retail store 118 using an in-store pickup option. The user input may be provided by the customer 126. Based on the received user input, the customer order may be generated and transmitted to the system 102. In this case, the customer order may be generated by the web client or the software application on the customer device 104. Additionally, or alternatively, the user input may be transmitted to the retail store management system 106, which may store the user input and generate the customer order. After the customer order is generated, the customer device 104 may be updated to display a message which may indicate that the customer order is placed. Also, the retail store management system 106 may transmit the customer order and/or details of the customer order to the system 102. The customer order may indicate a set of items purchased by the customer 126.

It should be noted that the process of placing a customer order through the customer device 104 may include several steps (such as item selection or payment) that are not mentioned in the foregoing description. A description of such steps is omitted from the disclosure for the sake of brevity.

By using the trained machine learning model 116, the system 102 may determine a first timeslot for an in-store pickup of the received customer order. The first timeslot may be one of the first set of timeslots available at the retail store 118 within the second period. In an embodiment, the received set of inputs and the data associated with the received customer order may be input to the trained machine learning model 116. Based on the input, the trained machine learning model 116 may output a result, which may include a score associated each timeslot of the first set of timeslots. From the first set of timeslots, the first timeslot may be determined as slot for which the score may be maximum (and/or above a threshold). In an embodiment, the trained machine learning model 116 may score the first set of timeslots based on a pickup wait time (estimate) associated with each timeslot. In such a case, the first timeslot may be determined such that the pickup wait time for the customer 126 within the first timeslot may be minimum or below a threshold time (e.g., a few minutes, such as 2-5 minutes). As the machine learning model 116 is trained on training data of a particular customer (such as the customer 126), the first timeslot may serve as a personalized recommendation (or best option) for the customer 126.

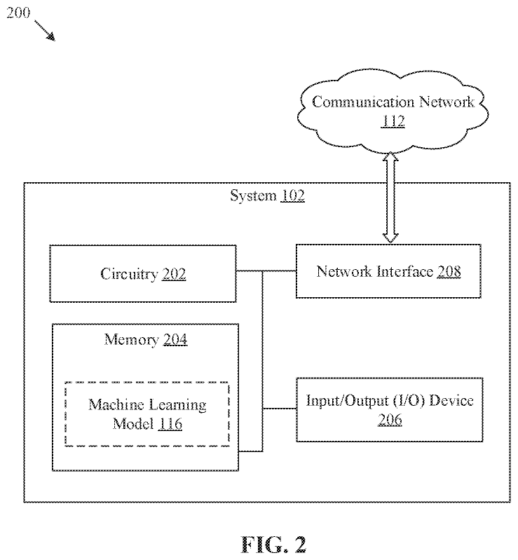

The system 102 may be configured to control the customer device 104 to display the determined first timeslot. For example, the first timeslot may be display on a user-interface of the client-side application or a software application of the customer device 104. Various operations of the system 102 for the personalized selection of pickup slots are described further, for example, in FIGS. 2, 3, 4, 5, and 6.

FIG. 2 is a block diagram that illustrates an exemplary system for personalized selection of pickup slots using a machine learning model, in accordance with an embodiment of the disclosure. FIG. 2 is explained in conjunction with elements from FIG. 1. With reference to FIG. 2, there is shown the system 102. The system 102 may include circuitry 202, a memory 204, an input/output (I/O) device 206, and a network interface 208. The circuitry 202 may be communicatively coupled to the memory 204, the I/O device 206, and the network interface 208. Through the network interface 208, the circuitry 202 may be configured to communicate with the customer device 104, the retail store management system 106, the set of worker devices 108, and/or the store manager device 110.

The circuitry 202 may include suitable logic, circuitry, and/or interfaces that may be configured to execute program instructions associated with different operations to be executed by the system 102. The circuitry 202 may be implemented based on a number of processor technologies known in the art. Examples of the processor technologies may include, but are not limited to, a Central Processing Unit (CPU), an x86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

The memory 204 may include suitable logic, circuitry, and/or interfaces that may be configured to store a set of instructions executable by the circuitry 202. The memory 204 may be configured to store operating systems and associated applications. In accordance with an embodiment, the memory 204 may be also configured to store the machine learning model 116. In addition, the memory 204 may also store the customer order that may be received from the customer device 104 and/or the set of inputs that may be received from the retail store management system 106. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input from a user (such as the customer 126). The I/O device 206 may be further configured to provide an output to the user. The I/O device 206 may include various input and output devices, which may be configured to communicate with the circuitry 202. Examples of the input devices may include, but are not limited to, a touch screen, a keyboard, a mouse, a joystick, and/or a microphone. Examples of the output devices may include, but are not limited to, a display screen and/or a speaker.

The network interface 208 may include suitable logic, circuitry, code, and/or interfaces that may be configured to facilitate communication between the circuitry 202, the customer device 104, the retail store management system 106, the set of worker devices 108, and/or the store manager device 110, via the communication network 112. The network interface 208 may be implemented by use of various known technologies to support wired or wireless communication of the system 102 with the communication network 112. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), a 5th generation network such as 5G new radio (NR) network, a 5G smart antenna, time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). The network interface 208 may be capable to communicate with a 5G communication network and will include appropriate 5G support functionality such as, but not limited to, a 5G NR, a V2X Infrastructure, and a 5G Smart Antenna.

The functions or operations executed by the system 102, as described in FIG. 1, may be performed by the circuitry 202. Operations executed by the circuitry 202 for the personalized selection of pickup slots are described in detail, for example, in FIGS. 3, 4, 5, 6, and 7.

FIG. 3 is a diagram that illustrates an exemplary processing pipeline for personalized selection of pickup slots using a machine learning model, in accordance with an embodiment of the disclosure. FIG. 3 is explained in conjunction with elements from FIG. 1 and FIG. 2. With reference to FIG. 3, there is shown a processing pipeline 300 of operations from 302 to 314 to depict personalized selection of pickup slots using a machine learning model (such as the machine learning model 116). The operations 302 to 314 of the processing pipeline 300 may be executed by the system 102 of FIG. 1 or the circuitry 202 of FIG. 2.

At 302, historical data 316 may be received. In an embodiment, the circuitry 202 may be configured to receive the historical data 316 related to a set of past customer orders placed by a customer (such as the customer 126) at a retail store (such as the retail store 118) within a first period (e.g., past few days, past few weeks, or past few months). The circuitry 202 may be configured to receive the historical data 316 from the retail store management system 106. The retail store management system 106 may retrieve the historical data 316 from the database 114 and may transmit the retrieved historical data 316 to the system 102. The historical data 316 related to the set of past customer orders may include, for example, information associated with past customer orders (for example, at least 30 customer orders) placed by the customer 126 within a first time period (such as past few weeks or past few months).

In an embodiment, for each customer order in the set of past customer orders, the historical data 316 may include suborders related information 316A, service time 3168, order placement information 316C, order pickup information 316D, and out-of-stock item information 316E. For example, the suborders related information 316A may include the suborders split into departments at the retail store 118, a size of each of the suborders, and the like. The service time 316B may refer to a time of service for each of the suborders. For each customer order, the order placement information 316C may include information associated with a date and time at which a respective customer order was placed. The order pickup information 316D may include information associated with a date and a timeslot at which the respective customer order was picked up. The out-of-stock item information 316E may include information associated with a number of items which were out-of-stock in each of the departments and within a duration of the first period.

At 304, a set of inputs may be received. In an embodiment, the circuitry 202 may be configured to receive the set of inputs from the retail store management system 106. The retail store management system 106 may retrieve the set of inputs from the database 114 and may transmit the retrieved set of inputs to the system 102. For example, a set of inputs 318 is shown. The set of inputs 318 may include slot-related information 318A, inventory information 318B, order preparation constraints 318C, parking slot information 318D, and objective function information 318E. The slot-related information 318A may be related to a first set of timeslots available at the retail store 118 within a second period (e.g., next few days or next few weeks). In an embodiment, the slot-related information 318A may include a number of timeslots (from the first set of timeslots) available each day and a length of each timeslot of the first set of timeslots. For example, the slot-related information 318A may indicate a set of 14 timeslots of half hour each on a certain day (e.g., Mar. 15, 2021). Example of the first set of timeslots may include, but is not limited to, 10:00 AM-10.30 AM, 10:30 AM-11:00 AM, 11:00 AM-11:30 AM, 11:30 AM-12:00 PM, 12:00 PM-12:30 PM, 12:30 PM-1:00 PM, 1:00 PM-1:30 PM, 2:30 PM-3:00 PM, 3:00 PM-3:30 PM, 3:30 PM-4:00 PM, 4:00 PM-4:30 PM, 5:30 PM-6:00 PM, 6:00 PM-6:30 PM, and 6:30 PM-7:00 PM. The number of timeslots within the first set of timeslots may be set based on availability of time within a given working day for the retail store 118 to service customer orders and an average or median service time to service each customer order. For example, the first set of timeslots may be set based on operational hours of the retail store 118 (e.g., 9:00 AM-7:30 PM) and one or more timeslots assigned for miscellaneous activities, such as stock-taking, restocking, or auditing (e.g., 9:00 AM-10:00 AM and 7 PM-7:30 PM). The first set of timeslots may be further set based on a set of time intervals of breaks taken on average by the set of human workers 122 of the retail store 118. For example, the breaks may include a first time-interval (such as, 1:30 PM-2:30 PM) for lunch and a second time interval (such as, 4:30 PM-5:30 PM) for evening coffee.

The inventory information 318B may be related to the items sold by the retail store 118. For example, the inventory information 318B may include information related to an identity and a quantity of different items available in each of the set of departments 120 and/or a warehouse associated with the retail store 118. In an embodiment, the inventory information 318B may include a database of the items sold by the retail store 118. For each of the items, the database of the items may include a unique product code (UPC) or an identifier, at least one of an item weight or an item volume, an item quantity, and a department to which the respective item may belong. The weight or volume of a unit of the item may be, for example, 2 lbs., 16 oz, or 750 ml. The quantity of the item may be, for example, a pack of 6 items. The department of the item may be, for example, the food-and-beverages department 120A. In the food-and-beverages department 120A, the sub-department of the item may be a dairy products sub-department (e.g., a dairy products aisle). The inventory information 318B may be used to identify a first set of items of the customer order and to check if such items are available in the inventory. Also, the inventory information 318B may be used to determine if a second set of items of the customer order is out-of-stock. Based on a UPC of each item in the inventory information 318B, the circuitry 202 may identify each item in the customer order and determine information indicative of the department of each item in the customer order.

The order preparation constraints 318C may be related to a number of human workers (e.g., the set of human workers 122) at the retail store 118. For example, the order preparation constraints 318C may include an average time or a median time that may be required by each human worker to service a sub-order of a certain size, including items associated with a certain department or sub-department of the retail store 118. In an embodiment, the order preparation constraints 318C may include a number of the human workers (in the set of human workers 122) who may be available in each timeslot of the first set of timeslots, a number of hours that each of the human workers (in the set of human workers 122) may work in a day, and a median time to fulfil an average customer order or suborder. For example, 4 human workers may be assigned to work in each of the set of departments 120 and in each of the 14 timeslots between 10 AM to 7 PM. Each of the set of human workers 122 may work for a total of 6 hours in the 14 timeslots to service customer orders.

The number of hours a human worker may be assigned to a department in a day may be used to assign tasks associated with servicing of the customer orders or suborders related to the department. Also, the number of human workers available in each timeslot and the number of hours that each human worker may work in the day may be used to assign tasks associated with servicing of the customer orders to each human worker (of the set of human workers 122). In some scenarios, there may be variations in the number of customer orders and the availability of the human workers on a given day or within a given period. For example, even though the working hours for each human worker may be predetermined (e.g., 6 hours), the availability of the human workers may vary as one or more human workers may be unavailable due to personal work or health reasons for a certain duration in the day.

The median time to fulfil an average customer order or suborder may be a useful statistic to assign tasks to the set of human workers 122 as a median value in a dataset may be robust to outliers. As an example, the median time to fulfil the average customer order may be 20 minutes. In certain cases, the order preparation constraints 318C may include a first median time associated with fulfilment of a small order (e.g., an order of a size less than a threshold (such as 5 items)) and a second median time associated with fulfilment of a large order (e.g., an order of a size greater than a threshold (such as 20 items)). As an example, the first median time may be 12 minutes and the second median time may be 25 minutes.

The parking slot information 318D may include a number of parking spots which may be available for the in-store pickup within a given duration (for example, a duration of an average pickup timeslot). The availability of parking spots may vary at the retail store 118 based on various factors, such as a time of day, a number of orders to be picked up at the time of day or within the given duration, and/or a number of customers at the retail store 118 for in-store purchase.

The objective function information 318E may include initial weights (or relative weights) for objectives, such as, but not limited to, a first objective to maximize a service level for the received customer order above a service level threshold and a second objective to maximize a resource utilization of the number of human workers within each of the first set of timeslots above a utilization threshold. The maximization of the service level for the received customer order may imply that the customer order is serviced in an assigned timeslot for the servicing of the customer order. For example, the expectation of the customer 126 may be met or even exceeded if the customer order is ready for pickup at the retail store 118 or at a parking spot of the retail store 118 before or at the start of a half hour timeslot booked by the customer 126 for the order pickup.

The second objective may be met based on a maximum utilization of the resources (e.g., the set of human workers 122 and/or the store manager 124) of the retail store 118. For example, the resources associated with the retail store 118 may include 6 human workers and a single store manager who may collaborate with the 6 human workers to service 2-3 customer order in every 30-minute timeslot on a typical day. If the resources associated with the retail store 118 is sufficient to service 10 customer orders in every 30-minute timeslot and there are not enough additional man-hours to handle 11th customer order (however small the customer order may be), then the utilization of the resources may be said to be maximized.

At 306, a set of training data may be prepared. In an embodiment, the circuitry 202 may be configured to prepare the set of training data based on the received historical data 316 and the received set of inputs 318. For example, the historical data 316 and the set of inputs 318 may be parsed into input features and output labels. The combination of input features and output labels may be referred to as the set of training data. Thereafter, such features may be fed as input to the machine learning model 116. Each of such features may include, for example, a datapoint from at least one of the slot-related information 318A, the inventory information 3188, the order preparation constraints 318C, the parking slot information 318D, and the objective function information 318E. The set of training data may include output labels, such as the date and the timeslot at which the respective customer order was picked up.

At 308, the machine learning model 116 may be trained. In an embodiment, the circuitry 202 may be configured to train the machine learning model 116 on the prepared set of training data. The machine learning model 116 may be trained for a timeslot prediction task of predicting a pick-up time slot for a new customer order. The method of training of the machine learning model 116 may depend on a type of the machine learning model 116. Details of training methods for machine learning models are well known in the art. Therefore, details of such training methods have been omitted for the sake of brevity. In an embodiment, the machine learning model 116 may be a support vector machine (SVM) model that may be trained using a suitable supervised learning method. In another example, the machine learning model 116 may be a deep neural network or a hybrid of several deep neural network(s) or other supervised learning models (such as SVM, an ensemble learning model, a decision tree, or a Naive Bayes).

As the historical data 316 grows over time, the number of features or datapoints in the prepared set of training data may increase. By way of example, and not limitation, once the historical data 316 of customer orders placed by the customer grows by a threshold number (for example, 10 orders), the machine learning model 116 may be retrained or a new machine learning model may be trained. For timeslot prediction of next few orders (for example, 10 orders) of the customer, the latest (or most recently) trained machine learning model may be used for predicting the pick-up time slot.

In an embodiment, the circuitry 202 may be configured to determine whether a retraining of the machine learning model 116 may be required based on a number of new customer orders in the historical data 316. In case the number of new customer orders in the historical data 316 is above a threshold, the circuitry 202 may determine that the retraining of the machine learning model 116 may be required. Otherwise, if the number of new customer orders in the historical data 316 is below the threshold, the circuitry 202 may determine that the retraining of the machine learning model 116 may not be required. The threshold may be, for example, 10 new orders, 20 new orders, 50 new orders, and the like. In an embodiment, the circuitry 202 may be configured to receive a user input, via the I/O device 206, to set the threshold. In another embodiment, the circuitry 202 may be configured to use a default threshold. For example, after addition of every 10 new customer orders in the historical data 316, the circuitry 202 may be configured to retrain the machine learning model 116.

At 310, a customer order may be received. In an embodiment, the circuitry 202 may be configured to receive the customer order, which may be placed by a customer (for example, the customer 126) at the retail store 118 and may have to be scheduled for an in-store pickup at the retail store 118 within the second period (for example, within next 5 days from the day the order is placed). The customer order may be indicative of a set of items that may be purchased by the customer 126 or may be added to a digital cart for purchase. As shown, for example, the customer device 104 may place a customer order 320 of the customer 126. The customer order 320 may be identified by an order ID, such as “1234”. The set of items in the customer order 320 may include, for example, a bread loaf, eggs, milk, hand-sanitizers, a night lamp, antacid strips, a pair of gent's socks, a set of power banks, and the like. In an embodiment, the customer order 320 may specify that the customer order 320 may have to be scheduled for an in-store pickup at the retail store 118.

The customer device 104 may transmit (directly or through the retail store management system 106) the generated customer order to the system 102. The circuitry 202 may receive the customer order from the customer device 104 (or from the retail store management system 106). In an embodiment, the circuitry 202 may be configured to process customer orders from a set of customers on a first-in-first-out (FIFO) basis. In other words, all the customer orders at the retail store 118 within a given period may be arranged in a queue and timeslot prediction for in-store pickup of each order in the queue may be performed on a FIFO basis. In an embodiment, the circuitry 202 may assign a priority to the customer orders based on one or more of a membership or loyalty points of a customer with the retail store 118, a number of items in the customer order, an invoiced amount of the customer order, a location-based rule for the customers (who placed the orders), or a payment mode associated with the customer order.

In an embodiment, the circuitry 202 may be configured to divide the customer order 320 into the suborders based on a number of departments (e.g., the set of departments 120) at the retail store 118. The division of the customer order 320 into the suborders may be based on the inventory information 318B. By way of example, and not limitation, the inventory information 318B may include the UPC code of each item. The UPC code may be used to identify the respective item and/or or sub-department to which the respective item belongs.

For example, the customer order 320 may be divided into 6 suborders based on the set of items in the customer order 320 and the individual departments (in the set of departments 120) to which the set of items may belong. The six suborders of customer order 320 may include a first suborder associated with the food-and-beverages department 120A, a second suborder associated with the toiletries-and-cosmetics department 1208, a third suborder associated with the home improvement department 120C, a fourth suborder associated with the medicines-and-drugs department 120D, a fifth suborder associated with the shoes-and-apparels department 120E, and a sixth suborder associated with the consumer electronics department 120N. As shown, for example, the first suborder may include the bread loaf, the eggs, and the milk, and the second suborder may include the hand-sanitizers. Further, the third suborder may include the night lamp, while the fourth suborder may include the antacid strips. In addition, the fifth suborder may include the pair of gent's socks, and the sixth suborder may include the set of power banks.

At 312, a first timeslot may be determined. In an embodiment, the circuitry 202 may be configured to determine, by using the trained machine learning model 116, the first timeslot of the first set of timeslots for the in-store pickup of the received customer order. In an embodiment, the circuitry 202 may prepare a set of input features based on the received set of inputs 318 and information related to the received customer order. Thereafter, the circuitry 202 may apply the trained machine learning model 116 on the prepared set of input features to generate a slot prediction result. The first timeslot may be determined based on the slot prediction result. For instance, the slot prediction result may include a score associated each timeslot of the first set of timeslots. From the first set of timeslots, the first timeslot may be determined as slot for which the score may be maximum and/or above a threshold.

The first timeslot may accommodate the received customer order (such as the customer order 320) and may match with a customer preference for pickup of orders. Also, the first timeslot may be determined such that a pickup wait time within the first timeslot may be minimum (e.g., a few minutes, such as, 2-5 minutes or 10% of the duration of the first timeslot). The determination of the first timeslot may be such that the first objective (i.e., the maximization of the service level for the received customer order) and the second objective (i.e., the maximization of the resource utilization of the number of the human workers) are satisfied.

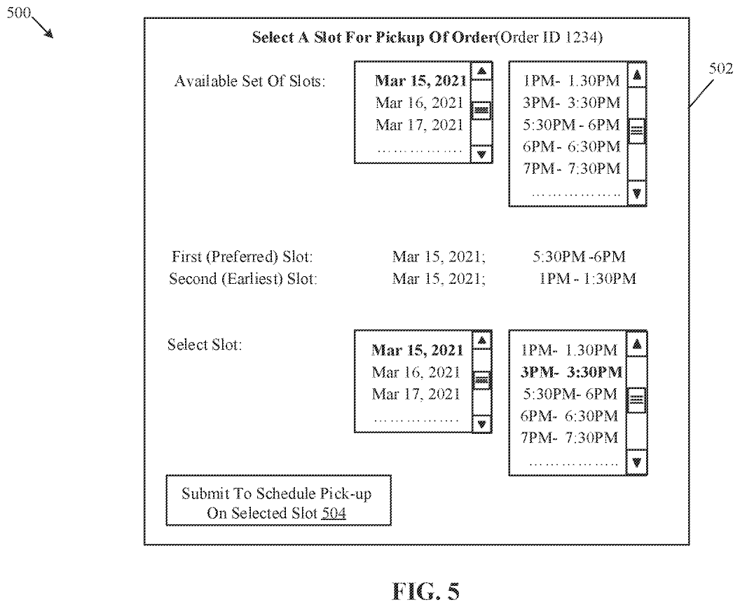

At 314, the first timeslot may be displayed. In an embodiment, the circuitry 202 may be configured to control the customer device 104 to display the determined first timeslot. The circuitry 202 may transmit information associated with the first timeslot to the customer device 104 and may control the user-interface of the web browser or the first software application of the customer device 104 to display the first timeslot. An example of a user-interface to display the first timeslot on the customer device 104 is provided, for example, in FIG. 5.

In an embodiment, the first timeslot may be displayed as a user-selectable option. If the customer (such as the customer 126) chooses the first timeslot for the in-store pickup, then the retail store 118 may be able to service a greater number of customer orders in the first set of timeslots (or within the second period). Also, the first timeslot may be suitable for the customer 126 as the customer 126 may have to wait for a minimal time for the pickup of his/her customer order from the retail store 118.

In an embodiment, the circuitry 202 may be configured to determine one or more items listed in the received customer order 320 to be out-of-stock at the retail store 118, based on the inventory information 318B. For example, the inventory information 318B may include information related to an identity and a quantity of different items available in each of the set of departments 120 and/or a warehouse associated with the retail store 118. Based on the identity and the quantity of items available in the retail store 118 and/or the warehouse associated with the retail store 118, one or more items listed in the customer order 320 may be determined to be out-of-stock. For example, the item availability information may indicate that out of the set of items in the customer order 320, one pair of the gents' socks (from the shoes-and-apparels department 120E) and two units of the power bank (from the consumer electronics department 120N) may be out-of-stock.

In an embodiment, the circuitry 202 may be configured to control the customer device 104 to further display a reward or an extra store credit which may be available for redemption. The reward or the extract store credit may be displayed based on the determination that the one or more items are out-of-stock. Based on the item availability information, a store credit may be determined for each out-of-stock item in the customer order 320. For example, a first store credit of 10 points may be determined for the out-of-stock gents socks. A second store credit of 60 points (i.e., 30 points for each of the 2 units) may be determined for the out-of-stock power banks. The total store credit of 70 points (i.e., 10+(30×2) points) may be determined for the out-of-stock items of the customer order 320. The circuitry 202 may be configured to control the customer device 104 to display the item availability information and the total store credit. The number of points in the total store credit may either be credited to an electronic wallet associated with the retail store 118 for redemption. The total store credit may be utilized by the customer 126 in a future customer order with the retail store 118.

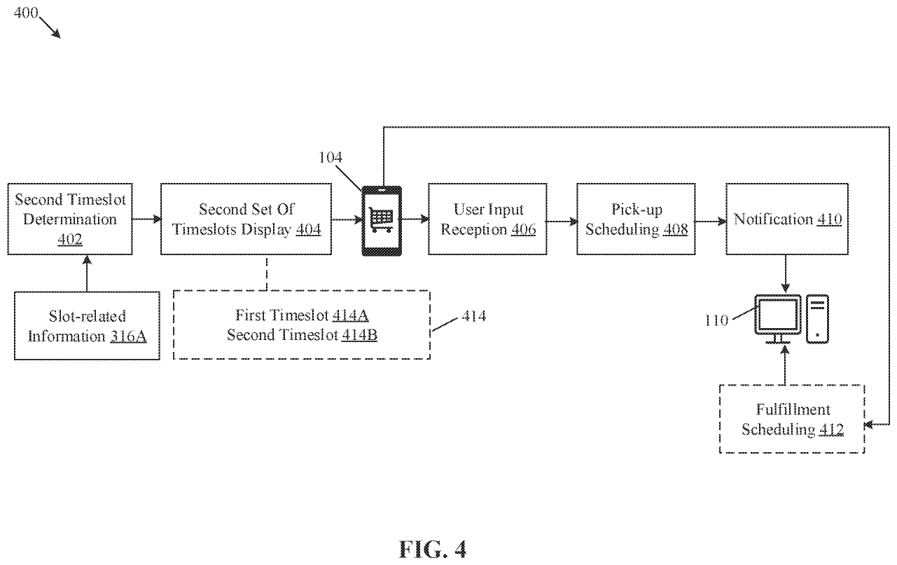

FIG. 4 is a diagram that illustrates another exemplary processing pipeline for personalized selection of pickup slots, in accordance with an embodiment of the disclosure. FIG. 4 is explained in conjunction with elements from FIG. 1, FIG. 2, and FIG. 3. With reference to FIG. 4, there is shown a processing pipeline 400 of operations from 402 to 412 to depict slot selection for personalized selection of pickup slots. The operations 402 to 412 of the processing pipeline 400 may be executed by the system 102 of FIG. 1 or the circuitry 202 of FIG. 2.

At 402, a second timeslot may be determined for the customer order (received at 310 of FIG. 3, for example). In an embodiment, the circuitry 202 may be configured to determine the second timeslot for the received customer order, based on the slot-related information 318A. The second timeslot may be earliest in the first set of timeslots and may accommodate the received customer order without a violation of a capacity constraint on the second timeslot. The capacity constraint may be indicative of a number (or a maximum number) of customer orders to be scheduled for in-store pickup within each timeslot of the first set of timeslots. In an embodiment, the circuitry 202 may determine the earliest available timeslot from the first set of timeslots, based on the number of customer orders that may be scheduled within each timeslot, a set of customer orders received prior to the current customer order, and customer orders which may be already scheduled in one or more of the first set of timeslots. The determined earliest available timeslot may be referred to as the second timeslot for the customer order 320.

At 404, a second set of timeslots may be displayed. In an embodiment, the circuitry 202 may be configured to control the customer device 104 to display the second set of timeslots (such as a second set of timeslots 414). The second set of timeslots 414 may be available within a third period and each timeslot of the second set of timeslots 414 may accommodate the received customer order 320, without a violation of the capacity constraint. For example, if the first period associated with the first set of timeslots corresponds to next 5 days from the time the customer order is placed, then the third period may correspond to one or more days within the 5-days period. The second set of timeslots 414 may include at least the first timeslot (determined in FIG. 3) and the second timeslot. As shown, for example, the second set of timeslots 414 may include a first timeslot 414A and a second timeslot 4148.

The circuitry 202 may transmit information associated with the second set of timeslots 414 to the customer device 104 and may control the user-interface of the web browser or the first software application of the customer device 104 to display the second set of timeslots 414. An example of a user-interface to display the first timeslot on the customer device 104 is provided, for example, in FIG. 5.

At 406, a user input may be received from the customer 126. In an embodiment, the circuitry 202 may be configured to receive the user input associated with the customer 126. At first, the customer device 104 may receive the user input via the user-interface of the web browser of the first software application. The user input may include a selection of a timeslot from the second set of timeslots 414 via the user-interface. The customer device 104 may transmit the received user input to the circuitry 202.

At 408, the pickup of the customer order 320 may be scheduled. In an embodiment, the circuitry 202 may be configured to schedule the in-store pickup of the received customer order 320, based on the received user input (at 406). The in-store pickup may be scheduled within a final timeslot (one of the second set of timeslots 414). For example, the final timeslot may be one of the first timeslot (determined using the trained machine learning model 116 in FIG. 3) or the second timeslot (which may be the earliest available timeslot).

At 410, at least one of customer device 104 or the store manager device 110 may be notified. In an embodiment, the circuitry 202 may be configured to transmit a notification to at least one of the customer device 104 or the store manager device 110. The transmitted notification may include an indication of the final timeslot, in which the customer order 320 may be scheduled for an in-store pickup from the retail store 118. The notification on the customer device 104 may inform the customer 126 about the final timeslot for in-store pickup and may include information, such as an order ID, a customer name, and a date associated with the final timeslot for pickup of the customer order 320. In some scenarios, the notification on the store manager device 110 may request the store manager 124 to assign tasks to one or more human workers for servicing the customer order 320, based on the final timeslot. Additionally, or alternatively, the notification on the store manager device 110 may include the final timeslot and information related to the customer order 320. The store manager device 110 may receive an input (from the store manager 124) indicative of whether or not the final timeslot is accepted.

At 412, a fulfillment of the customer order 320 may be scheduled. In an embodiment, the circuitry 202 may be configured to schedule the fulfillment of the customer order 320 that may be already scheduled for the in-store pickup within the final timeslot. For example, the circuitry 202 may divide the customer order 320 into suborders based on a department or sub-department to which each item of the set of items in the customer order 320 belongs. The circuitry 202 may allocate one or more order servicing tasks associated with each of the suborders to one or more human workers of the set of human workers 122. The task allocation may be based on one or more of, but not limited to, a department associated with each item in the customer order, a department assigned to each human worker, a current availability of each human worker for the one or more order servicing tasks, and a median servicing time for each order/suborder. The fulfillment of the customer order 320 or suborders of the customer order 320 may be scheduled such that the customer order 320 is serviced before the start of the final timeslot for the in-store pickup of the customer order 320.

In an embodiment, the circuitry 202 may transmit information related to the schedule for the fulfillment of the customer order 320 to the store manager device 110. The information related to the schedule for the fulfillment of the customer order 320 may include details related to the order servicing tasks assigned to the one or more human workers. Based on the received information, the store manager device 110 may transmit a notification to a worker device of a respective human worker (of the set of human workers 122). Based on the notification received on a respective worker device, the one or more order servicing tasks may be executed by the human worker. The one or more order servicing tasks may include, for example, an identification of an item of a suborder from a sub-department or a department of the retail store 118, a collection and packaging of the identified items, an invoicing of the customer order, and delivery/placement of packaged items at a pickup location near or within a premise of the retail store 118.

FIG. 5 is a diagram that illustrates an example user-interface of a customer device for display of one or more timeslots, in accordance with an embodiment of the disclosure. FIG. 5 is explained in conjunction with elements from FIG. 1, FIG. 2, FIG. 3, and FIG. 4. With reference to FIG. 5, there is shown a diagram 500 which includes a user-interface 502 of the customer device 104. The user-interface 502 may be associated with a web browser or a software application installed on the customer device 104.

As shown in FIG. 5, the user-interface 502 may display one or more timeslots to schedule the in-store pickup of the received customer order (e.g., the customer order 320 with the order ID “1234”). The user-interface 502 may enable a selection of one of the displayed one or more timeslots based on a user input from the customer 126. In an embodiment, the user-interface 502 may display an available set of slots (i.e., the first set of timeslots). For example, the user-interface 502 may display the available set of slots on certain dates, such as “Mar. 15, 2021”, “Mar. 16, 2021”, and “Mar. 17, 2021”. Examples of the available set of slots on the date “Mar. 15, 2021” may include 1 PM-1:30 PM, 3 PM-3:30 PM, 5:30 PM-6 PM, 6 PM-6:30 PM, and 7 PM-7:30 PM. In an embodiment, the user-interface 502 may also display the second set of timeslots 414 which may include a first the first timeslot 414A and the second timeslot 414B (i.e., earliest available timeslot). For example, if the customer order 320 is placed on Mar. 14, 2021 at 1:00 PM, then the first slot may be the 5:30 PM-6 PM slot on Mar. 15, 2021 and the second slot may be the 1 PM-1:30 PM slot on Mar. 15, 2021.

In an embodiment, the user-interface 502 may display one or more user-interface elements to enable the customer 126 to provide a user input for selection of the final timeslot. Examples of such displayed user-interface elements may include, but are not limited to, a dropdown, a date-time picker, a textbox, a set of radio buttons, or a set of checkboxes. In an embodiment, the customer device 104 may display one or more notifications, which may prompt the customer 126 to select the first timeslot 414A. Based on the user input received from the customer 126 via the displayed user-interface elements, the customer device 104 may select the final timeslot. The user-interface 502 may further include a submit button 504. Based on a selection of the submit button 504, the selected final timeslot may be confirmed for the in-store pickup of the customer order 320. Thereafter, the customer device 104 may transmit information associated with the selected final timeslot to the circuitry 202 to schedule the in-store pickup of the customer order 320 within the final timeslot.

It should be noted that the diagram 500 is presented merely as an example of a user-interface and should not be construed as limiting for the scope of the disclosure. Though the disclosure is described with respect to a retail store, the scope of the disclosure may not be so limited. The disclosure may also be implemented in various other scenarios such as, but not limited to, a food take-away restaurant with multiple cuisines or menu options or a banking or financial institution with multiple departments.

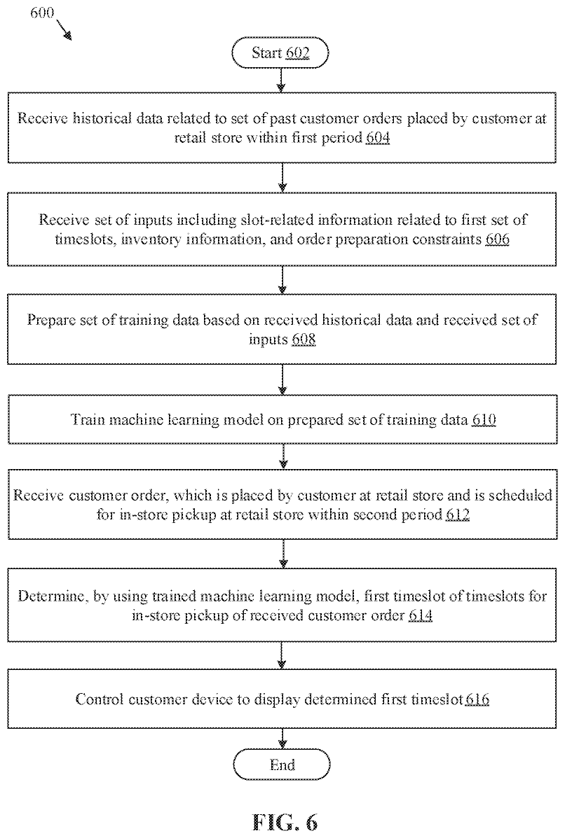

FIG. 6 is a flowchart that illustrates exemplary operations for personalized selection of pickup slots using a machine learning model, in accordance with an embodiment of the disclosure. FIG. 6 is described in conjunction with elements from FIG. 1, FIG. 2, FIG. 3, FIG. 4, and FIG. 5. With reference to FIG. 6, there is shown a flowchart 600. The flowchart 600 may include operations from 604 to 616, which may be implemented on the system 102. The flowchart 600 may start at 602 and proceed to 604.

At 604, historical data (e.g., the historical data 316) related to a set of past customer orders may be received. In an embodiment, the circuitry 202 may be configured to receive the historical data 316 related to a set of past customer orders placed by a customer 126 at a retail store 118 within a first period.

At 606, the set of inputs (e.g., the set of inputs 318) including the slot-related information 318A related to the first set of timeslots, the inventory information 3188, and the order preparation constraints 318C may be received. In an embodiment, the circuitry 202 may be configured to receive the set of inputs (e.g., the set of inputs 318), such as, the slot-related information 318A, the inventory information 318B, and the order preparation constraints 318C. The set of inputs 318 may be received from the database 114, via the retail store management system 106. Details related to the set of inputs 318 are described further, for example, in FIG. 3.

At 608, a set of training data may be prepared. In an embodiment, the circuitry 202 may be configured to prepare the set of training data based on the received historical data, and the received set of inputs 318. The preparation of the training data is described further, for example, in FIG. 3.

At 610, a machine learning model may be trained. In an embodiment, the circuitry 202 may be configured to train the machine learning model (such as the machine learning model 116) on the prepared set of training data for a timeslot prediction task. The training of the machine learning model 116 is described further, for example, in FIG. 1 and FIG. 3.

At 612, a customer order (e.g., the customer order 320) may be received for an in-store pickup at the retail store 118. In an embodiment, the circuitry 202 may be configured to receive the customer order 320, which may be placed by the customer 126 at the retail store 118 and may have to be scheduled for the in-store pickup at the retail store 118 within the second period. The customer order 320 may be received from the customer device 104.

At 614, a first timeslot may be determined from the first set of timeslots. In an embodiment, the circuitry 202 may be configured to determine, using the trained machine learning model, the first timeslot of the first set of timeslots for the in-store pickup of the received customer order 320. The determination of the first timeslot is described further, for example, in FIGS. 3 and 4.

At 616, the customer device 104 may be controlled to display the determined first timeslot. In an embodiment, the circuitry 202 may be configured to control the customer device 104 to display the determined first timeslot. The circuitry 202 may transmit information associated with the first timeslot to the customer device 104 and may control the user-interface of the web browser or the first software application of the customer device 104 to display the first timeslot to the customer 126. An example of a user-interface to display the first timeslot on the customer device 104 is provided, for example, in FIG. 6. Control may pass to the end.

Although the flowchart 600 is illustrated as discrete operations, such as 604, 606, 608, 610, 612, 614, and 616, the disclosure is not so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory computer-readable medium and/or storage medium having stored thereon, computer-executable instructions executable by a machine and/or a computer to operate a system (for example, the system 102). Such instructions may cause the system 102 to perform operations that include receiving historical data (e.g., the historical data 316) related to a set of past customer orders placed by a customer at a retail store (e.g., the retail store 118) within a first period. The operations may further include receiving a set of inputs including, but not limited to, slot-related information (e.g., the slot-related information 318A) related to a first set timeslots available at the retail store 118 within a second period, inventory information (e.g., the inventory information 318B), and order preparation constraints (e.g., the order preparation constraints 318C) related to a number of human workers (e.g., the set of human workers 122) at the retail store 118. The operations may further include preparing a set of training data based on the received historical data 316 and the received set of inputs (e.g., the slot-related information 318A, the inventory information 318B, and the order preparation constraints 318C). The operations may further include training a machine learning model (e.g., the machine learning model) on the prepared set of training data for a timeslot prediction task. The operations may further include receiving a customer order (e.g., the customer order 320), which may be placed by the customer at the retail store 118 and is to be scheduled for an in-store pickup at the retail store 118 within the second period. The operations may further include determining, by using the trained machine learning model, a first timeslot of the first set of timeslots for the in-store pickup of the received customer order 320. The operations may further include controlling a customer device (e.g., the customer device 104) to display the determined first timeslot.

Exemplary aspects of the disclosure may provide a system (such as the system 102 of FIG. 1) that includes circuitry (such as the circuitry 202). The circuitry 202 may be configured to receive historical data (e.g., the historical data 316) related to a set of past customer orders placed by a customer at a retail store (e.g., the retail store 118) within a first period. The circuitry 202 may be further configured to receive a set of inputs including, but not limited to, slot-related information (e.g., the slot-related information 318A) related to a first set timeslots available at the retail store 118 within a second period, inventory information (e.g., the inventory information 318B), and order preparation constraints (e.g., the order preparation constraints 318C) related to a number of human workers (e.g., the set of human workers 122) at the retail store 118. The circuitry 202 may be further configured to prepare a set of training data based on the received historical data 316 and the received set of inputs (e.g., the slot-related information 318A, the inventory information 3188, and the order preparation constraints 318C). The circuitry 202 may be further configured to train a machine learning model (e.g., the machine learning model) on the prepared set of training data for a timeslot prediction task. The circuitry 202 may be further configured to receive a customer order (e.g., the customer order 320), which may be placed by the customer at the retail store 118 and is to be scheduled for an in-store pickup at the retail store 118 within the second period. The circuitry 202 may be further configured to determine, by using the trained machine learning model, a first timeslot of the first set of timeslots for the in-store pickup of the received customer order 320. The circuitry 202 may be further configured to control a customer device (e.g., the customer device 104) to display the determined first timeslot.

In an embodiment, the received set of inputs may further include a number of parking spots (e.g., the parking slot information 318D) which are available for the in-store pickup, and initial weights (e.g., the objective function information 318E) for objectives. Herein, the objectives may include, but are not limited to, a first objective (e.g., the first objective) to maximize a service level for the received customer order 320 above a service level threshold, and a second objective (e.g., the second objective) to maximize a resource utilization of the number of human workers within each of the first set of timeslots above a utilization threshold.

In an embodiment, the slot-related information 318A may include, but is not limited to, a number of timeslots available within the first set of timeslots on each day and a length of each timeslot of the first set of timeslots. Further, the inventory information 3188 includes a database of the items sold by the retail store 118. For each of the items, the database may include a unique product code or identifier, at least one of an item weight or an item volume, an item quantity, and a department to which the respective item belongs. Further, the order preparation constraints 318C may include, but are not limited to, the number of human workers available in each timeslot of the first set of timeslots, a number of hours each human worker works in a day, and a median time to fulfil an average customer order or suborder.

In an embodiment, the circuitry 202 may be further configured to prepare a set of input features based on the received set of inputs 318 and information related to the received customer order 320. The circuitry 202 may be further configured to apply the trained machine learning model on the prepared set of input features to generate a slot prediction result. The first timeslot is determined based on the slot prediction result.

In an embodiment, the circuitry 202 may be further configured to determine a second timeslot for the received customer order 320, based on the slot-related information 318A. The second timeslot may be earliest in the first set of timeslots and may accommodate the received customer order in accordance with the capacity constraint. In an embodiment, the circuitry 202 may be further configured to control the customer device 104 to display a second set of timeslots, which may be available within a third period and each of which may accommodate the received customer order 320. The second set of timeslots may include at least the first timeslot and the second timeslot. The circuitry 202 may be further configured to receive a user input via the customer device 104. Further, based on the received user input, the circuitry 202 may be configured to schedule the in-store pickup of the received customer order 320 within a final timeslot, which may be included in the second set of timeslots.

In an embodiment, for each customer order in the set of past customer orders, the historical data 316 may include suborders split into departments at the retail store, a size of each of the suborders, a time of service for each of the suborders, a date and time at which a respective customer order was placed, a date and a timeslot at which the respective customer order was picked up, and a number of items which were out-of-stock in each of the departments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A system, comprising:
circuitry configured to:
receive historical data related to a set of past customer orders placed by a customer at a retail store within a first period;
receive a set of inputs comprising:
slot-related information related to a first set of timeslots available at the retail store within a second period,
inventory information related to items sold by the retail store, and
order preparation constraints related to a number of human workers at the retail store;
prepare a set of training data based on the received historical data and the received set of inputs;
train a machine learning model on the prepared set of training data for a timeslot prediction task;
receive a customer order, which is placed by the customer at the retail store and is to be scheduled for an in-store pickup at the retail store within the second period;
determine, by using the trained machine learning model, a first timeslot of the first set of timeslots for the in-store pickup of the received customer order; and
control a customer device to display the determined first timeslot.

2. The system according to claim 1, wherein the received set of inputs further comprise:
a number of parking spots which are available for the in-store pickup, and initial weights for objectives which include:
a first objective to maximize a service level for the received customer order above a service level threshold, and
a second objective to maximize a resource utilization of the number of human workers within each of the first set of timeslots above a utilization threshold.

3. The system according to claim 1, wherein the slot-related information comprises a number of timeslots available within the first set of timeslots on each day and a length of each timeslot of the first set of timeslots.

4. The system according to claim 1, wherein the inventory information comprises a database of the items sold by the retail store, and
wherein for each of the items, the database comprises a unique product code or identifier, at least one of an item weight or an item volume, an item quantity, and a department to which the respective item belongs.

5. The system according to claim 1, wherein the order preparation constraints comprise of:
the number of human workers available in each timeslot of the first set of timeslots,
a number of hours each human worker works in a day, and
a median time to fulfil an average customer order or suborder.

6. The system according to claim 1, wherein the circuitry is further configured to:
prepare a set of input features based on the received set of inputs and information related to the received customer order; and
apply the trained machine learning model on the prepared set of input features to generate a slot prediction result, wherein the first timeslot is determined based on the slot prediction result.

7. The system according to claim 1, wherein the circuitry is further configured to determine a second timeslot for the received customer order, based on the slot-related information, and
wherein the second timeslot is earliest in the first set of timeslots and accommodates the received customer order without a violation of a capacity constraint on the second timeslot.

8. The system according to claim 7, wherein the circuitry is further configured to:
control the customer device to display a second set of timeslots, which are available within a third period and each of which accommodates the received customer order,
wherein the second set of timeslots comprises at least the first timeslot and the second timeslot;
receive a user input via the customer device; and
schedule, based on the received user input, the in-store pickup of the received customer order within a final timeslot, which is included in the second set of timeslots.

9. The system according to claim 1, wherein for each customer order of the set of past customer orders, the historical data comprises suborders split into departments at the retail store, a size of each of the suborders, a time of service for each of the suborders, a date and time at which a respective customer order was placed, a date and a timeslot at which the respective customer order was picked up, and a numbers of items which were out-of-stock in each of the departments.

10. A method, comprising:
in a system:
receiving historical data related to a set of past customer orders placed by a customer at a retail store within a first period;
receiving a set of inputs comprising:
slot-related information related to a first set of timeslots available at the retail store within a second period,
inventory information related to items sold by the retail store, and
order preparation constraints related to a number of human workers at the retail store;
preparing a set of training data based on the received historical data and the received set of inputs;
training a machine learning model on the prepared set of training data for a timeslot prediction task;
receiving a customer order, which is placed by the customer at the retail store and is to be scheduled for an in-store pickup at the retail store within the second period;
determining, by using the trained machine learning model, a first timeslot of the first set of timeslots for the in-store pickup of the received customer order; and
controlling a customer device to display the determined first timeslot.

11. The method according to claim 10, wherein the received set of inputs further comprise:
a number of parking spots which are available for the in-store pickup, and
initial weights for objectives which include:
a first objective to maximize a service level for the received customer order above a service level threshold, and
a second objective to maximize a resource utilization of the number of human workers within each of the first set of timeslots above a utilization threshold.

12. The method according to claim 10, wherein the slot-related information comprises a number of timeslots available within the first set of timeslots on each day and a length of each timeslot of the first set of timeslots.

13. The method according to claim 10, wherein the inventory information comprises a database of the items sold by the retail store, and
wherein for each of the items, the database comprises a unique product code or identifier, an item weight, an item volume, an item quantity, and a department to which the respective item belongs.

14. The method according to claim 10, wherein the order preparation constraints comprise:
a number of human workers available in each timeslot of the first set of timeslots,
a number of hours each of the human workers works in a day, and
a median time to fulfil an average customer order or suborder.

15. The method according to claim 10, further comprising:
preparing a set of input features based on the received set of inputs and information related to the received customer order; and
applying the trained machine learning model on the prepared set of input features to generate a slot prediction result, wherein the first timeslot is determined based on the slot prediction result.

16. The method according to claim 10, further comprising determining a second timeslot for the received customer order, based on the slot-related information,
wherein the second timeslot is earliest in the first set of timeslots and accommodates the received customer order without a violation of a capacity constraint on the second timeslot.

17. The method according to claim 16, further comprising:
controlling the customer device to display a second set of timeslots, which are available within a third period and each of which accommodates the received customer order,
wherein the second set of timeslots comprises at least the first timeslot and the second timeslot;
receiving a user input via the customer device; and
scheduling, based on the received user input, the in-store pickup of the received customer order within a final timeslot, which is included in the second set of timeslots.

18. The method according to claim 10, wherein for each customer order of the set of past customer orders, the historical data comprises suborders split into departments at the retail store, a size of each of the suborders, a time of service for each of the suborders, a date and time at which a respective customer order was placed, a date and a timeslot at which the respective customer order was picked up, and a numbers of items which were out-of-stock in each of the departments.

19. A non-transitory computer-readable medium having stored thereon, computer-executable instructions that when executed by a system, causes the system to execute operations, the operations comprising:
receiving historical data related to a set of past customer orders placed by a customer at a retail store within a first period;
receiving a set of inputs comprising:
slot-related information related to a first set of timeslots available at the retail store within a second period,
inventory information related to items sold by the retail store, and
order preparation constraints related to a number of human workers at the retail store;
preparing a set of training data based on the received historical data and the received set of inputs;
training a machine learning model on the prepared set of training data for a timeslot prediction task;
receiving a customer order, which is placed by the customer at the retail store and is to be scheduled for an in-store pickup at the retail store within the second period;
determining, by using the trained machine learning model, a first timeslot of the first set of timeslots for the in-store pickup of the received customer order; and
controlling a customer device to display the determined first timeslot.

20. The non-transitory computer-readable medium according to claim 19, wherein the operations further comprise:
preparing a set of input features based on the received set of inputs and information related to the received customer order; and
applying the trained machine learning model on the prepared set of input features to generate a slot prediction result, wherein the first timeslot is determined based on the slot prediction result.
